(19) United States
(12) Patent Application Publication
(10) Pub. No.: US 2023/0088026 A1
(43) Pub. Date: Mar. 23, 2023

(54) SYSTEM FOR DETECTION AND TERMINATION OF THERMAL RUNAWAY IN BATTERY CELLS

(71) Applicant: GM GLOBAL TECHNOLOGY OPERATIONS LLC, Detroit, MI (US)

(72) Inventors: Xiaofeng Yang, Troy, MI (US); Jian Gao, Auburn Hills, MI (US); Scott E. Parrish, Farmington Hills, MI (US)

(21) Appl. No.: 17/478,297

(22) Filed: Sep. 17, 2021

(51) Int. Cl. B60L 58/26; H01M 10/613; H01M 10/625; H01M 10/44; B60L 3/00

(52) U.S. Cl. CPC B60L 58/26; H01M 10/613; H01M 10/625; H01M 10/445; B60L 3/0046; H01M 2220/20; H01M 2200/20; B60L 2250/10

(57) ABSTRACT

A control system to prevent thermal runaway includes an enclosure housing a plurality of battery cells of a battery module. Each of the battery cells is a pouch-type battery cell includes a core and a pouch enclosing the core and including one or more portions along one or more side surfaces thereof that are attached together by adhesive to form a seal. The adhesive is configured to release the seal when pressure within the pouch exceeds a predetermine pressure value. A gas sensor is configured to sense a predetermined gas in the enclosure. A valve is configured to selectively deliver thermal control fluid from a source. A controller is configured to open the valve in response to the gas sensor sensing the predetermined gas in the enclosure.

### CROSS-REFERENCE TO RELATED APPLICATIONS

The present disclosure is related to U.S. patent application Ser. No. 17/078,466 filed on Oct. 23, 2020. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery systems for hybrid and battery electric vehicles, and more particularly to detection and termination of thermal runaway in a battery systems.

Battery electric vehicles (BEVs) include one or more battery packs each including one or more battery modules. Each of the battery modules includes one or more battery cells. A power control system is used to control charging and/or discharging of the battery packs during charging and/or driving. During driving, one or more electric motors of the BEV or hybrid receive power from the battery system to provide propulsion for the vehicle and/or return power to the battery system during regeneration.

During operation of the BEV, the battery cells may experience heating due to charging and discharging. Battery life may be adversely impacted by operation for extended periods at higher temperatures. As a result, battery cooling systems may be used to maintain the temperature of the battery system within a predetermined temperature range. For example, a normal temperature range for a lithium ion battery may be in a range from 45° C. to 50° C. Various faults that may occur in the battery system may cause excessive heating of the battery cells in the battery system beyond what the battery cooling system can control.

### SUMMARY

A control system to prevent thermal runaway includes an enclosure housing a plurality of battery cells of a battery module. Each of the battery cells is a pouch-type battery cell includes a core and a pouch enclosing the core and including one or more portions along one or more side surfaces thereof that are attached together by adhesive to form a seal. The adhesive is configured to release the seal when pressure within the pouch exceeds a predetermine pressure value. A gas sensor is configured to sense a predetermined gas in the enclosure. A valve is configured to selectively deliver thermal control fluid from a source. A controller is configured to open the valve in response to the gas sensor sensing the predetermined gas in the enclosure.

In other features, the plurality of battery cells have a length, a height and a thickness. The lengths are greater than the heights, and wherein the lengths of the plurality of battery cells are arranged side-by-side in a horizontal direction in the enclosure. The plurality of battery cells have a length, a height and a thickness. The lengths are greater than the heights. The lengths of the plurality of battery cells are arranged side-by-side in a vertical direction in the enclosure.

In other features, the adhesive is arranged along at least one of the side surfaces of the pouch. The adhesive is arranged along two or more of the side surfaces of the pouch. The predetermined pressure value is greater than 2 bar and less than 4 bar.

In other features, the adhesive is arranged along the side surfaces of the pouch. The controller is further configured to alter at least one parameter of a battery system in response to the gas sensor sensing the concentration of the predetermined gas in the enclosure above the predetermined concentration.

In other features, the at least one parameter of the battery system includes at least one of triggering an alarm; reducing vehicle loading; stopping charging of the battery system; increasing ventilation/cooling of the battery system; isolating the battery module; and fast discharging other battery modules in the battery system.

A battery module includes a plurality of battery cells, wherein each of the battery cells is a pouch-type battery cell including a core and a pouch enclosing the core and including one or more portions along side surfaces thereof that are attached together by adhesive to form a seal. The adhesive is configured to release the seal when pressure within the pouch exceeds a predetermine pressure value. An enclosure encloses the plurality of battery cells and includes a thermal control fluid at least partially immersing the plurality of battery cells.

In other features, the battery cells have a length, a height and a thickness. The lengths are greater than the heights. The lengths are arranged side-by-side in a horizontal direction. The battery cells have a length, a height and a thickness. The lengths are greater than the heights, and wherein the lengths are arranged side-by-side in a vertical direction. The adhesive is arranged along at least one of the side surfaces of the pouch.

In other features, the adhesive is arranged along two or more of the side surfaces of the pouch. The predetermined pressure value is greater than or equal to 2 bar and less than or equal to 4 bar. The adhesive is arranged along all of the side surfaces of the pouch.

A non-transitory computer-readable medium storing instructions that, when executed by a controller, cause the controller to perform a method comprising monitoring a gas sensor a gas sensor configured to sense a predetermined gas in an enclosure housing a plurality of battery cells of a battery module. Each of the battery cells is a pouch-type battery cell including a core and a pouch enclosing the core and including one or more portions along one or more side surfaces thereof that are attached together by adhesive to form a seal. The adhesive is configured to release the seal when pressure within the pouch exceeds a predetermine pressure value. The method includes opening a valve configured to selectively deliver thermal control fluid from a source in response to a gas sensor sensing the predetermined gas in the enclosure.

In other features, the method include altering at least one parameter of a battery system in response to the gas sensor sensing the concentration of the predetermined gas in the enclosure above the predetermined concentration.

In other features, the at least one parameter of the battery system includes at least one of triggering an alarm; reducing vehicle loading; stopping charging of the battery system; increasing ventilation/cooling of the battery system; isolating the battery module; and fast discharging other battery modules in the battery system.

In other features, the at least one parameter of the battery system includes reducing vehicle loading.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a battery cell according to the present disclosure;

FIG. 2 is a side cross-sectional view of the battery cell of FIG. 1;

FIG. 3A is a perspective view of an example of a battery module including one or more battery cells that are arranged side-by-side in a horizontal position in an enclosure and at least partially immersed in fluid according to the present disclosure;

FIG. 3B is a plan view of an example of a battery pack including one or more battery modules of FIG. 3A according to the present disclosure;

FIG. 4A is a perspective view of an example of a battery module including one or more battery cells that are arranged side-by-side in a vertical position in an enclosure and at least partially immersed in fluid according to the present disclosure;

FIG. 4B is a plan view of an example of a battery pack including one or more battery modules of FIG. 4A according to the present disclosure;

FIG. 5A is a perspective view of an example of a battery module including one or more battery cells that are arranged side-by-side in a horizontal position according to the present disclosure;

FIG. 5B is a plan view of an example of a battery pack including one or more battery modules of FIG. 5A according to the present disclosure;

FIG. 6A is a perspective view of an example of a battery module including one or more battery cells that are arranged side-by-side in a vertical position according to the present disclosure;

FIG. 6B is a plan view of an example of a battery pack including one or more battery modules of FIG. 6A according to the present disclosure;

FIG. 7 is a functional block diagram of an example of a system including a controller for preventing thermal runaway; and

FIG. 8 is a flowchart illustrating an example of a method for operating the controller of FIG. 7.

In the drawings, reference numbers may be reused to identify similar and/or identical elements.

### DETAILED DESCRIPTION

While a control system for detecting and preventing thermal runaway in battery cells of a battery system is described below in the context of battery electric vehicles, the present disclosure can be used for battery systems of hybrid or other vehicles and/or in other non-vehicle implementations.

When some battery fault conditions occur, the temperature of the battery can increase beyond the normal temperature range and may cause thermal runaway. Battery thermal runaway refers to a chemical process that is accelerated by increased temperature, in turn releasing energy that further increases temperature. For example, battery thermal runaway occurs when a battery cell has an elevated temperature due to thermal failure, mechanical failure, internal/external short circuiting, and/or electrochemical abnormalities.

Vent gases are precursors to battery thermal runaway. For example, the vent gases may include carbonate produced by evaporation of electrolyte or another vent gas produced by the battery cell when the battery cell is heated above a predetermined temperature range.

A battery pack may include one or more battery modules. One or more battery cells are arranged in an enclosure of the battery modules. The enclosure is at least partially filled with a thermal control fluid such as a water, dielectric or another fluid. Normally, the pouches of the battery cells are sealed and will not allow the thermal control fluid to contact components in the battery cell(s). Each of the battery cells is a pouch-type battery cell. The pouch includes an adhesive on one or more sides thereof that releases when the pressure of the vent gases in the pouch is greater than a predetermined pressure. When the pouch opens due to the pressure of the vent gases, the thermal control fluid enters the pouch through the opening and contacts components of the battery cell to stop thermal runaway.

In another implementation, the enclosure of the battery module is not filled with thermal control fluid during normal operation. The battery cells are pouch-type battery cells with the adhesive seal(s) described above. An off gas sensor senses vent gases in the enclosure of the battery module. When the off gas sensor senses a vent gas concentration greater than a predetermined concentration, a valve is opened to supply thermal control fluid from a source through a conduit and into the enclosure. The thermal control fluid contacts the core of the pouch that opened due to increased pressure and stops thermal runaway.

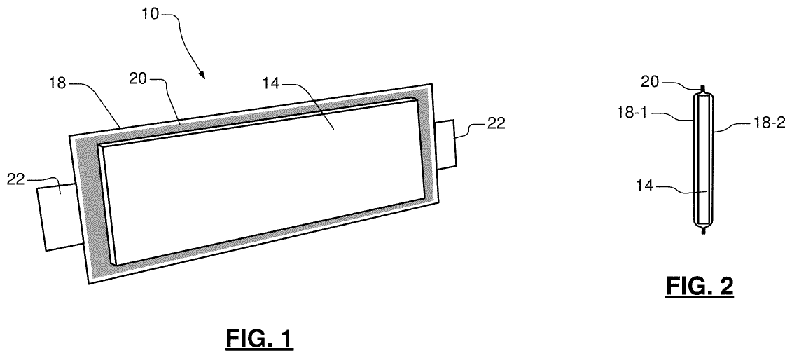

Referring now to FIGS. 1 and 2, a battery cell 10 such as a sealed pouch-type battery cell includes a core 14 that includes components of the battery cell such as the anode, separator, cathode and/or electrolyte. The core 14 is enclosed in a pouch 18. Terminals 22 extend from the pouch on opposite sides thereof. The pouch 18 may include a top side, a bottom side and/or lateral sides. One or more portions of the sides are connected together by adhesive that forms a seal that opens in response to pressure in the pouch 16 rising above a predetermined pressure. The seal is fluid tight below the predetermined pressure to prevent thermal control fluid from entering the pouch.

As the temperature of the battery cell 10 increases, the electrolyte in the pouch 18 begins to evaporate, which creates vent gas that increases the pressure within the pouch 18. The adhesive 20 opens when the pressure within the sealed pouch 18 exceeds a predetermined pressure value. In FIG. 2, opposite top and bottom sides 18-1 and 18-2 of the pouch 18 are shown attached using adhesive 20. Laterals sides of the pouch may also be attached using the adhesive 20 as shown in FIG. 1.

In some examples, the predetermined pressure value is selected to be greater than the pressure that is experienced by the battery cell when heated during normal operation. The predetermined pressure is sufficiently low to release when the battery cell is experiencing temperatures associated with an elevated temperature range above the normal operating temperature range. For example, normal operating temperature may correspond to 45° C. to 50° C. and an elevated temperature range may correspond to 80° C. to 100° C. In some examples, the pressure of the vent gases when the temperature is in the elevated temperature range exceeds the predetermined pressure. For example, the predetermined pressure is in a range from 2 to 4 bar (e.g. 2 or 3 bar), although other pressure values can be used.

As can be appreciated, the number, size, length and location of the portions of the pouch 18 including the adhesive 20 can be varied as shown in FIG. 1. For example, all of the side surfaces of the pouch 18 can include the adhesive 20. Alternately, one or more sides of the pouch 18 can include the adhesive 20. Alternately, only portions of one or more sides of the pouch 18 can include the adhesive 20 that releases while other portions include stronger adhesive. In some examples, the portions of the pouch 18 including the adhesive 20 are located in regions that are below the thermal control fluid level.

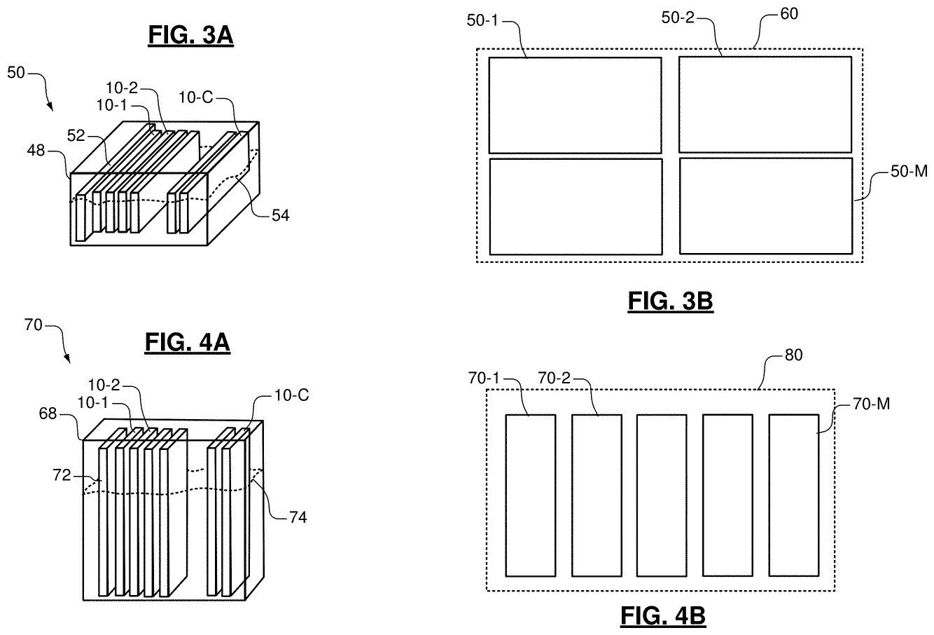

Referring now to FIGS. 3A and 3B, another battery module 50 is shown. In FIG. 3A, an enclosure 48 for a battery module 50 houses one or more battery cells 10-1, 10-2, . . . , and 10-C (collectively or individually battery cells 10) (where C is an integer) that are arranged side-by-side in a horizontal position and at least partially immersed in a thermal control fluid 54. In some examples, a battery management module 52 or another device may also be arranged in the enclosure 48. In FIG. 3B, a battery pack 60 includes one or more battery modules 50-1, 50-2, . . . , and 50-M (collectively or individually battery modules 50) (where M is an integer).

When the battery cells 10 are operating in the normal temperature range, the pressure within the pouch 18 stays below the predetermined pressure. As the battery cells 10 are heated above the normal temperature range due to a fault or for another reason, the pressure of vent gases within the pouch 18 increases above the predetermined pressure and the adhesive 20 releases at one or more locations of the pouch 18. The thermal control fluid 54 in the enclosure 48 enters the opening in the pouch(es) and contacts components in the pouch(es) 18 that opened to prevent thermal runaway.

Referring now to FIGS. 4A and 4B, an example implementation of the battery cell 10 of FIGS. 1 and 2 is shown. In FIG. 4A, an enclosure 68 of a battery module 70 houses one or more battery cells 10-1, 10-2, . . . , and 10-C (collectively or individually battery cells 10) (where C is an integer) that are arranged side-by-side in a vertical position and at least partially immersed in a thermal control fluid 74. In some examples, a battery management module 72 may also be arranged in enclosure 68. In FIG. 3B, a battery pack 80 includes one or more battery modules 70-1, 70-2, . . . , and 70-M (collectively or individually battery modules 70) (where M is an integer). The system in FIGS. 4A and 4B operates in a manner similar to FIGS. 3A and 3B.

In other examples, the battery cells in the battery modules described above are not immersed in thermal control fluid during normal operation. Rather, the battery modules include an off gas sensor that senses gases that are released by the electrolyte as the temperature of the electrolyte increases and one or more pouches open. Generally, the off gas sensor senses carbonate that evaporates from the electrolyte although other off gases that occur when the core is heated can be sensed. In response to detecting the off gases, a controller opens a valve to supply the thermal control fluid through a conduit to the corresponding battery module. The valve can be located at the fluid source, at the battery module or in locations therebetween. As can be appreciated, the fluid source have a volume smaller than the volume required to accommodate thermal runaway in all of the battery modules (to reduce weight) since not all of the battery modules are likely to fail at the same time.

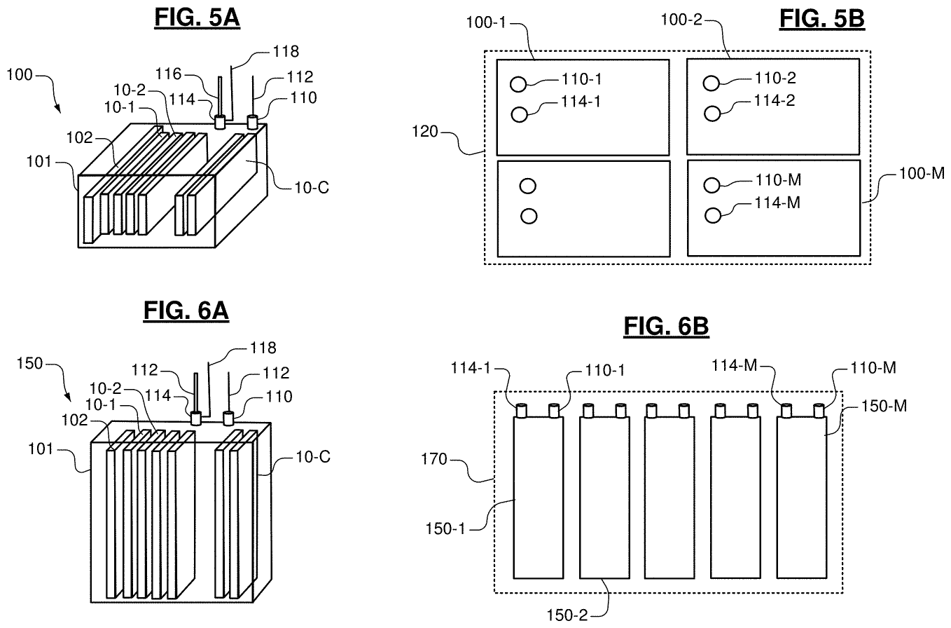

Referring now to FIGS. 5A and 5B, an example implementation of a battery module 100 that is not normally immersed in thermal control fluid is shown. In FIG. 5A, an enclosure 101 of a battery module 100 houses one or more battery cells 10-1, 10-2, . . . , and 10-C (collectively or individually battery cells 10) (where C is an integer) that are arranged side-by-side in a horizontal position. In some examples, a battery management module 102 may also be arranged in enclosure 101.

An off gas sensor 110 is also connected by a conductor 112 to a controller described below and senses gases within the battery module 100. A valve 114 is connected by a conduit 116 to a source of thermal control fluid and can be selectively opened to supply the thermal control fluid to the battery module 100. The valve 114 is also connected by a connector 118 to a controller described below. In FIG. 5B, a battery pack 120 includes one or more battery modules 100-1, 100-2, . . . , and 100-M (collectively or individually battery modules 100) (where M is an integer).

During operation, the battery cells 10 operate in the normal temperature range and the pressure of the vent gases within the pouch 18 stays below the predetermined pressure. As the battery cells 10 are heated above the normal temperature range due to a fault or other reason, the pressure of the vent gases within the pouch 18 increases above the predetermined pressure range. The pouch 18 opens and the off gas sensor 110 senses gases indicating that one or more of the pouches 18 opened. The valve 114 is opened and thermal control fluid is supplied to the enclosure 101 from a fluid source. The thermal control fluid in the enclosure 101 contacts components in the pouch(es) 18 that opened to prevent thermal runaway.

Referring now to FIGS. 6A and 6B, another example implementation of a battery module 150 that is not normally immersed in thermal control fluid is shown. In FIG. 6A, a battery module 150 includes one or more battery cells 10-1, 10-2, . . . , and 10-C (collectively or individually battery cells 10) (where C is an integer) that are arranged side-by-side in a vertical position. An off gas sensor 110 is also connected by a conductor 112 to a controller described below and senses gases within the battery module 150. A valve 114 is connected by a conduit 116 to a source of thermal control fluid and can be selectively opened to supply the thermal control fluid to the battery module 100. The valve 114 is also connected by a connector 118 to a controller described below. In FIG. 6B, a battery pack 170 includes one or more battery modules 150-1, 150-2, . . . , and 150-M (collectively or individually battery modules 150) (where M is an integer). The system in FIGS. 6A and 6B operates in a manner similar to FIGS. 5A and 5B.

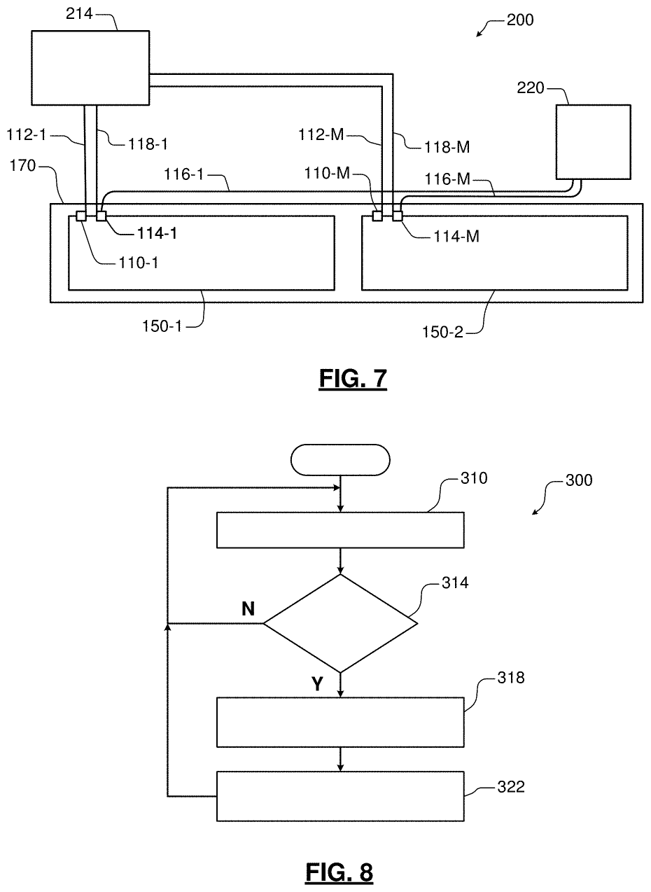

Referring now to FIG. 7, a system 200 includes one or more of the battery packs described herein (e.g. the battery pack 170 is shown, although other battery packs may be used). A controller 214 communicates with valves 110-1, 110-2, . . . , 110-M and off gas sensors 114-1, 114-2, . . . , and 114-M via conductors 112-1, 112-2, . . . , and 112-M and 118-1, 118-2, . . . , and 118-M, respectively. A fluid source 220 is connected by conduits 116-1. 116-2, . . . , and 116-M to housings of the battery modules 100-1, 100-2, . . . , and 100-M, respectively. While the valves 114 are shown located at the battery modules, the valves 110 can be arranged in other locations such as at the fluid source 220 or at locations therebetween.

Referring now to FIG. 8, a method 300 for operating the system 200 is shown. At 310, the off gas sensors are monitored. When the off gas sensor senses the off gas has a concentration above a predetermined value, an off gas event occurs. At 314, the method determines whether an off gas event has occurred. If 314 is true, the method opens a valve corresponding to the off gas sensor with the event at 318. At 322, the off gas event may also be used to optionally adjust one or more operating parameters of the vehicle.

For example in response to sensing the off gas event, a battery management system can initiate termination/safety strategies such as triggering an alarm, reducing vehicle loading, stopping charging, increasing ventilation/cooling, isolating or fast discharging other battery cell(s), etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A control system to prevent thermal runaway, comprising:
an enclosure housing a plurality of battery cells of a battery module,
wherein each of the battery cells is a pouch-type battery cell including:
a core; and
a pouch enclosing the core and including one or more portions along one or more side surfaces thereof that are attached together by adhesive to form a seal,
wherein the adhesive is configured to release the seal when pressure within the pouch exceeds a predetermine pressure value; and
a gas sensor configured to sense a predetermined gas in the enclosure;
a valve configured to selectively deliver thermal control fluid from a source; and
a controller configured to open the valve in response to the gas sensor sensing the predetermined gas in the enclosure.

2. The control system of claim 1, wherein the plurality of battery cells have a length, a height and a thickness, wherein the lengths are greater than the heights, and wherein the lengths of the plurality of battery cells are arranged side-by-side in a horizontal direction in the enclosure.

3. The control system of claim 1, wherein the plurality of battery cells have a length, a height and a thickness, wherein the lengths are greater than the heights, and wherein the lengths of the plurality of battery cells are arranged side-by-side in a vertical direction in the enclosure.

4. The control system of claim 1, wherein the adhesive is arranged along at least one of the side surfaces of the pouch.

5. The control system of claim 1, wherein the adhesive is arranged along two or more of the side surfaces of the pouch.

6. The control system of claim 1, wherein the predetermined pressure value is greater than 2 bar and less than 4 bar.

7. The control system of claim 1, wherein the adhesive is arranged along the side surfaces of the pouch.

8. The control system of claim 1, wherein the controller is further configured to alter at least one parameter of a battery system in response to the gas sensor sensing the concentration of the predetermined gas in the enclosure above the predetermined concentration.

9. The control system of claim 8, wherein the at least one parameter of the battery system includes at least one of:
triggering an alarm;
reducing vehicle loading;
stopping charging of the battery system;
increasing ventilation/cooling of the battery system;
isolating the battery module; and
fast discharging other battery modules in the battery system.

10. A battery module comprising:
a plurality of battery cells, wherein each of the battery cells is a pouch-type battery cell including:
a core; and
a pouch enclosing the core and including one or more portions along side surfaces thereof that are attached together by adhesive to form a seal,
wherein the adhesive is configured to release the seal when pressure within the pouch exceeds a predetermine pressure value; and
an enclosure enclosing the plurality of battery cells and including a thermal control fluid at least partially immersing the plurality of battery cells.

11. The battery module of claim 10, wherein the battery cells have a length, a height and a thickness, wherein the lengths are greater than the heights, and wherein the lengths are arranged side-by-side in a horizontal direction.

12. The battery module of claim 10, wherein the battery cells have a length, a height and a thickness, wherein the lengths are greater than the heights, and wherein the lengths are arranged side-by-side in a vertical direction.

13. The battery module of claim 10, wherein the adhesive is arranged along at least one of the side surfaces of the pouch.

14. The battery module of claim 10, wherein the adhesive is arranged along two or more of the side surfaces of the pouch.

15. The battery module of claim 11, wherein the predetermined pressure value is greater than or equal to 2 bar and less than or equal to 4 bar.

16. The battery module of claim 11, wherein the adhesive is arranged along all of the side surfaces of the pouch.

17. A non-transitory computer-readable medium storing instructions that, when executed by a controller, cause the controller to perform a method comprising:
monitoring a gas sensor a gas sensor configured to sense a predetermined gas in an enclosure housing a plurality of battery cells of a battery module,
wherein each of the battery cells is a pouch-type battery cell including:
a core; and
a pouch enclosing the core and including one or more portions along one or more side surfaces thereof that are attached together by adhesive to form a seal,
wherein the adhesive is configured to release the seal when pressure within the pouch exceeds a predetermine pressure value; and
opening a valve configured to selectively deliver thermal control fluid from a source in response to a gas sensor sensing the predetermined gas in the enclosure.

18. The computer readable medium of claim 17, further comprising altering at least one parameter of a battery system in response to the gas sensor sensing the concentration of the predetermined gas in the enclosure above the predetermined concentration.

19. The computer readable medium of claim 18, wherein the at least one parameter of the battery system includes at least one of:
triggering an alarm;
reducing vehicle loading;
stopping charging of the battery system;
increasing ventilation/cooling of the battery system;
isolating the battery module; and
fast discharging other battery modules in the battery system.

20. The computer readable medium of claim 18, wherein the at least one parameter of the battery system includes reducing vehicle loading.
